(19) United States
(12) Patent Application Publication
(10) Pub. No.: US 2008/0180261 A1
(43) Pub. Date: Jul. 31, 2008

(54) Carbon monoxide and explosive gas shut off system

(76) Inventor: Harold Shirlee, Little Rock, AR (US)

Correspondence Address: Harold Shirlee, 5406 Dreher Lane, Little Rock, AR, 72209, US

(21) Appl. No.: 12/003,500

(22) Filed: Dec. 26, 2007

Related U.S. Application Data
(63) Continuation of application No. 11/699,057, filed on Jan. 29, 2007.

(51) Int. Cl. G08B 17/10

(52) U.S. Cl. 340/632

(57) ABSTRACT

The Carbon Monoxide and Explosive Gas Shut Off System is an invention that will shut off the source of carbon monoxide and explosive gas at the time it is first detected by the carbon monoxide and explosive gas detector. This will save lives.

### BACKGROUND OF THE CARBON MONOXIDE AND EXPLOSIVE GAS SHUT OFF SYSTEM

There are many types of carbon monoxide and explosive gas detectors on the market that will detect carbon monoxide and explosives gases. Unfortunately, there isn't any on the market that will actually shut off the source of carbon monoxide or explosive gases once they have been detected. Thus, there is a need for a safety system that will not only detect carbon monoxide and explosive gases, but will go a step farther by shutting down the source (furnace) that is producing the carbon monoxide or explosive gas.

The carbon monoxide and explosive gas shut off system invention will not only detect carbon monoxide and explosive gases, but it will also shut off the source (furnace) that is producing the carbon monoxide or explosive gas. This will result in human lives being saved as well as reducing property damage from explosive gases.

### SUMMARY OF THE CARBON MONOXIDE AND EXPLOSIVE GAS SHUT OFF SYSTEM

The purpose of this invention is to shut off the source of carbon monoxide or explosive gases before they become life threaten. To accomplish this objective a carbon monoxide and explosive gas shut off system will be installed between the gas supply line and the furnace. The carbon monoxide and explosive gas detector that send the signal that causes the shut off system to shut the supply of gas off from the furnace will be installed according to instructions.

When carbon monoxide or explosive gases are detected not only will this invention send out a warning sound, but it will also shut the source of carbon monoxide or explosive gases off from the furnace. This will result in human lives being saved as well as preventing property damage from explosives gases.

### BRIEF DESCRIPTION OF THE DRAWING OF THE CARBON MONOXIDE AND EXPLOSIVE GAS SHUT OFF SYSTEM

FIG. 1: Is an inside view of the carbon monoxide and explosive gas detector. The feature that makes this detector different than the other carbon monoxide and explosive gas detector is that it has a transmitter (FIG. 1 part number 7) that sends a signal to the carbon monoxide and explosive gas shut off system.

FIG. 2: Is an inside view of the carbon monoxide and explosive gas shut off system. It shows how this system safely shuts the supply source of carbon monoxide and explosive gas off by shutting off the supply line from the furnace or stove.

### DETAIL DESCRIPTION AND OPERATION OF THE CARBON MONOXIDE AND EXPLOSIVE GAS DETECTOR ALARM

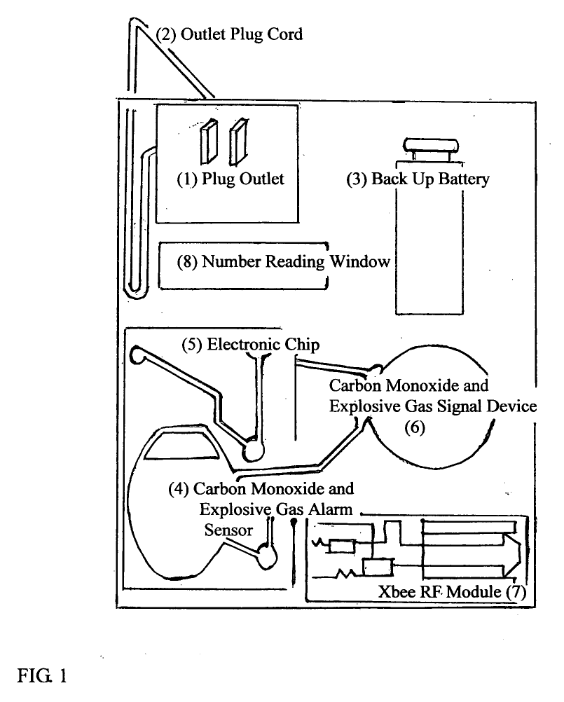

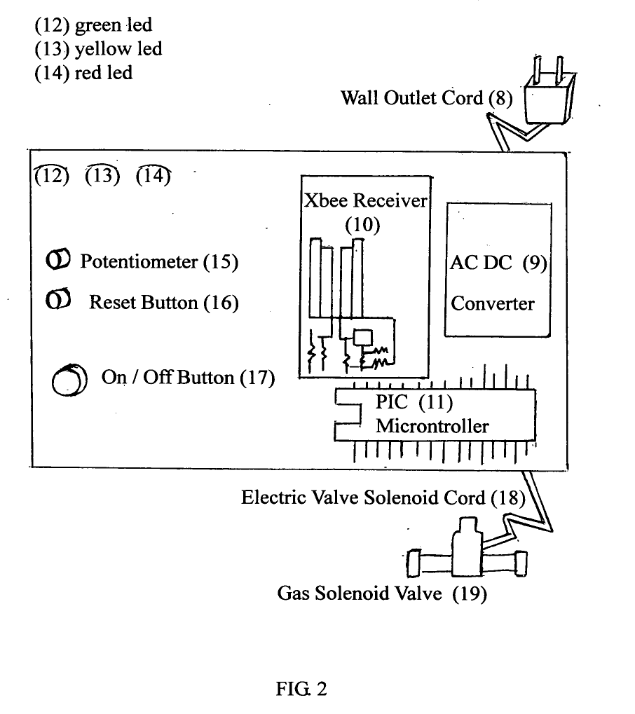

The Carbon Monoxide and Explosive Gas Detector (FIG. 1) comes as a part of the Carbon Monoxide Shut Off System. It is operated by 110 V AC (1, 2) having a back up battery (3). First a carbon monoxide and explosive gas sensor (4) will detect carbon monoxide or explosive gas. It will send that detection through an electronic chip (5) to an alarm signal device (6) that makes the alarm sound. A Xbee RF module board (7) is wired directly into an alarm signal device (6). Therefore the same signal that the electronic chip (5) sends to the alarm signal device (6) is also sent to the Xbee RF module board (7). The Xbee RF module board (7) transmits a signal to the Shut Off System (FIG. 2) at the same time that the carbon monoxide and explosive gas alarm is sounding.

### Detailed Description and Operation of the Carbon Monoxide and Explosive Gas Shut off System (FIG. 2)

The Carbon Monoxide and Explosive Gas Shut Off System is powered from a 110 V AC (8), using a 5V AC-DC converter (9). The Carbon Monoxide and Explosive Gas Shut Off System receives the transmitted signal from a carbon monoxide and explosive gas detector (FIG. 1) via another Xbee module board (10) configured as a receiver. A PIC microcontroller (11) controls the functionality of the Shut Off System. When the Shut Off System is armed (turned on) a PIC microcontroller (11) causes a green LED (12) to light. Upon receiving a signal from a Xbee module board receiver (10) a PIC microcontroller (11) will cause a yellow LED (13) to light. PIC lights are set by a user controller potentiometer (15). If at the end of the delay time the user has not turned off the Alarm Shut Off System with the off button (17), or pressed a reset button (16), a PIC Microcontroller (11) will send a signal through an electrical cord (18) to a gas solenoid valve (19) to shut off the gas from the incoming gas supply line. Once the gas supply line is shut off the PIC microcontroller (11) will cause a red LED (14) to light showing that the Carbon Monoxide and Explosive Gas Shut Off System has shut off the gas supply from the appliance. Thus, the appliance will not be able to produce carbon monoxide or explosive gas. This will save lives.

RESET: The user may restore the supply of gas to an appliance by pressing a reset button (16). A green LED (12) will come on. The green LED (12) means that the Carbon Monoxide and Explosive Gas Shut Off System is reset and armed again.

1. A carbon monoxide and explosive gas shut off system comprising: a wall outlet plug, an outlet plug cord, a back up battery, a carbon monoxide and explosive gas sensor, an electronic chip, a carbon monoxide and explosive gas signal device, a Xbee RF module board transmitter, an electric wall plug cord, an AC DC converter, a Xbee receiver, a PIC microcontroller, a green led, a yellow led, a red led, a potentiometer, a reset button, an on/off switch, an electric gas solenoid cord, and an electric gas solenoid valve.
